(19) United States
(12) Patent Application Publication
(10) Pub. No.: US 2010/0060128 A1
(43) Pub. Date: Mar. 11, 2010

(54) HOT CATHODE FLUORESCENT LAMP

(76) Inventors: Shiro Otake, Osaka (JP); Teruaki Shigeta, Osaka (JP); Takeshi Arakawa, Kyoto (JP); Nobuhiro Shimizu, Nara (JP)

Correspondence Address: SNELL & WILMER L.L.P. (Panasonic), 600 ANTON BOULEVARD, SUITE 1400, COSTA MESA, CA, 92626, US

(21) Appl. No.: 12/447,613

(22) PCT Filed: Nov. 2, 2007
(86) PCT No.: PCT/JP2007/071431

§ 371 Date: Apr. 28, 2009

(30) Foreign Application Priority Data
Nov. 2, 2006 (JP) 2006-299666

(51) Int. Cl. H01J 61/04

(52) U.S. Cl. 313/37

(57) ABSTRACT

A hot-cathode fluorescent lamp includes a pair of filament coils (4) at the respective ends of a glass bulb. Each filament coil (4) has a coiled portion (4a) coated with an electron emissive material. Each coiled portion is covered by a heat-resistant sleeves (7). At least a region of the inner circumferential surface of the sleeve is electrically insulating. The insulating region prevents a short circuit between the coiled portion of the filament coil and the inner circumferential surface of the sleeve that would otherwise occur upon lighting. Occurrence of such a short circuit would cause lighting to start without the coil portion being sufficiently pre-heated, which results in excessive sputtering of the electron emissive material to shorten the lamp life.

### TECHNICAL FIELD

The present invention relates to a hot-cathode fluorescent lamp mainly used as a backlight in a liquid crystal display apparatus.

### BACKGROUND ART

In recent years there have been demands for larger size liquid crystal display apparatuses, particularly for liquid crystal television receivers and the like. In accordance with such demands, there are also demands for larger size low-pressure discharge lamps to be used as backlights for liquid crystal television receivers.

In response to such demands for larger size liquid crystal television receivers, the present inventors have considered employing a hot-cathode fluorescent lamp as a backlight in view of various advantages including the following. That is, in comparison to cold-cathode fluorescent lamps, hot-cathode fluorescent lamps have higher luminous efficiency, emit a relatively large amount of light, and are easy to assemble.

Generally, a hot-cathode fluorescent lamp is provided with a pair of filament coils coated with electron emissive material. However, there is a problem that the electron emissive material sputters during lighting, causing the hot-cathode fluorescent lamp to have a shorter life than a cold-cathode fluorescent lamp. Patent Document 1 discloses a technique for suppressing such sputtering. Specifically, Patent Document 1 states that a metal sleeve is provided to cover a coiled portion of a filament coil in order to suppress the collision of ions with the filament coil, and thus the occurrence of sputtering is suppressed (see paragraph [0019]).

### Patent Document 1: Japanese Patent Application Publication No. 2005-235749

### DISCLOSURE OF THE INVENTION

### Problems the Invention is Attempting to Solve

Unfortunately, however, the conventional hot-cathode fluorescent lamp mentioned above involves the risk of a short circuit between a coiled portion of a filament coil and a metal sleeve covering the coiled portion. Occurrence of a short circuit causes the lamp to start to emit light, without the filament coil being sufficiently preheated. Compared with the state where the lamp starts to emit light after the filament coil is sufficiently heated, the electron emissive material tends to be sputtered excessively, which undesirably accelerates consumption of the electron emissive material and thus shortens the lamp life.

The present invention is made in view of the above problems and aims to provide a hot-cathode fluorescent lamp capable of preventing a short circuit between a coiled portion of a filament coil and a sleeve covering the coiled portion, and thus suppressing shortening of the lamp life.

### Means for Solving the Problems

In order to achieve the above aim, one aspect of the present invention provides a hot-cathode fluorescent lamp that includes: a glass bulb; a pair of filament coils disposed at respective ends of the glass bulb, each filament coil having a coiled portion coated with an electron emissive material; and a heat-resistant sleeve disposed to cover one of the coiled portions. The heat-resistant sleeve has an inner circumferential surface at least a region of which has an insulating property.

### Effects of the Invention

According to the present invention, the heat-resistant sleeve of the hot-cathode fluorescent lamp has the inner circumferential surface at least a region of which has an insulating property. This configuration prevents occurrence of a short circuit between the heat-resistant sleeve and the coiled portion during lighting, so that the electron emissive material applied to the coiled portion is protected from being excessively sputtered and thus from being excessively consumed. As a result, shortening of the lamp life is prevented.

### BRIEF DESCRIPTION OF THE DRAWINGS

FIG. 1A is a schematic cross-sectional view of a hot-cathode fluorescent lamp of a first embodiment of the present invention, and FIG. 1B is a cross-sectional view of a principal part of FIG. 1A;

FIG. 2 is a schematic view of an electrode unit according to the first embodiment; and

FIGS. 3A-3C are sectional views of variations of the first embodiment, taken along an imaginary plane shown in FIG. 2.

### REFERENCE NUMERALS

1 Hot-cathode fluorescent lamp
2 Bulb
2a Fluorescent film
3 Electrode unit
3a Electron emissive material
4 Filament coil
4a Coiled portion
4b First lead portion
4c Second lead portion
5a, 5b Connecting member
6a, 6b Lead-in wire
7 Sleeve
8 Sleeve lead
19 Body
20 Insulating Film

### BEST MODE FOR CARRYING OUT THE INVENTION

### First Embodiment

The following describes a hot-cathode fluorescent lamp of a first embodiment of the present invention, with reference to the drawings.

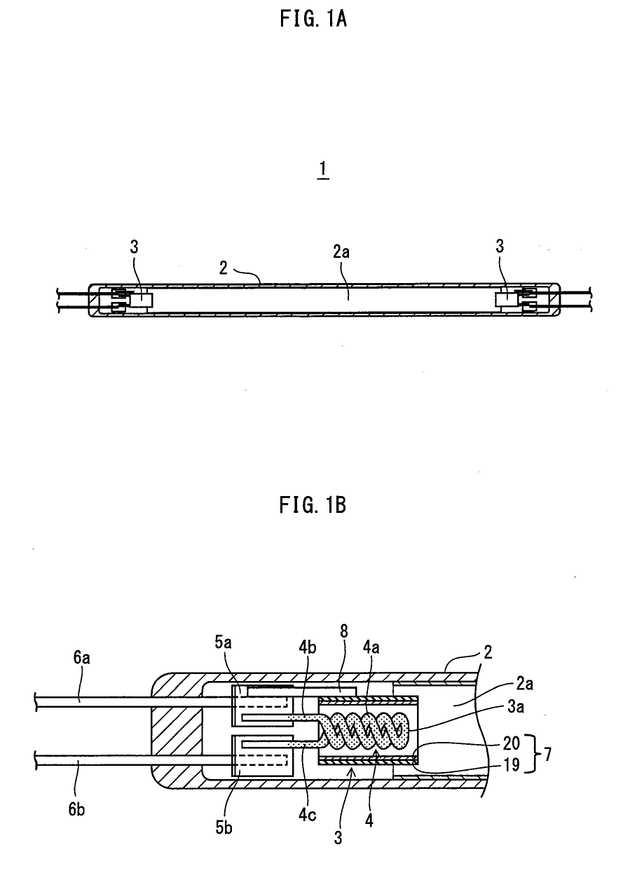

FIG. 1A is a schematic cross-sectional view of the hot-cathode fluorescent lamp of the first embodiment, and FIG. 1B is a cross-sectional view of a principal part of FIG. 1A. In FIG. 1A, only a bulb 2 and a fluorescent film 2a formed on an inner surface of the bulb 2 are shown in cross-section. In FIG. 1B, only the bulb 2, the fluorescent film 2a and a sleeve 7 are shown in cross-section. Although FIG. 1B shows only one of electrode units 3 and the surrounding area thereof in cross-section, the other electrode unit 3 and the surrounding area thereof have the same structure as shown in FIG. 1B.

As shown in FIG. 1A, the hot-cathode fluorescent lamp 1 according to the present embodiment includes the bulb 2 which, for example, is a tubular glass bulb having an inner diameter of no less than 5.0 [mm] and no greater than several millimeters. The hot-cathode fluorescent lamp 1 also includes the electrode units 3 housed at respective ends of the bulb 2.

The inner surface of the bulb 2 is coated substantially entirely with a fluorescent film 2a formed thereon, except the part of the inner surface at end portions of the bulb 2. Three types of fluorescent materials are used for the fluorescent film 2a, specific examples being red (Y₂O₃:Eu) , green (LaPO₄:Ce, Tb) and blue (BaMg₂Al₁₆O₂₇:Eu, Mn). The bulb 2 is filled with a rare gas and a luminescent material. Examples of the rare gas include an argon(Ar)-neon (Ne) gas, and examples of the luminescent material include mercury (Hg).

As shown in FIG. 1B, each electrode unit 3 is composed of a filament coil 4, a sleeve 7, a sleeve lead 8, and connecting members 5a and 5b. The filament coil 4 is composed of a coiled portion 4a, a first lead portion 4b, and a second lead portion 4c. The coiled portion 4a is wound in a spiral form and the sleeve 7 is disposed to house the coiled portion 4a.

The sleeve 7 is made of nickel (Ni), molybdenum (Mo), or the like, for instance. The axis of the sleeve 7 is substantially parallel to the winding axis of the coiled portion 4a.

The inner diameter of the sleeve 7 is sufficiently greater than the outer diameter of the coiled portion 4a, so that the sleeve 7 does not contact the coiled portion 4a housed therein. In addition, the outer diameter of the sleeve 7 is sufficiently smaller than the inner diameter of the bulb 2, so that the sleeve 7 does not contact the bulb 2.

The outer diameter of the coiled portion 4a is no less than several millimeters but less than 5 [mm], for instance. The first lead portion 4b extends from one end of the coiled portion 4a toward a closer one of the ends of the bulb 2. Similarly, the second lead portion 4c extends from the other end of the coiled portion 4a toward the closer end of the bulb 2.

The filament coil 4 is made of a wire which may have, as the main constituent, tungsten (W), tungsten-rhenium (Re-W), or the like. A wire made mainly of tungsten-rhenium (Re-W) has higher strength under heat, as compared with a wire made mainly of tungsten (W). For this reason, a wire having Tungsten-rhenium (Re-W) as the main constituent is used for the filament coil 4 in the present embodiment.

Wires with a diameter of 25 [μm] to 70 [μm] are usable for the filament coil 4. In the case of a double coil (double helical structure), it is preferable to use a wire having a diameter of 45 [μm] to 55 [μm], from the point of view of both ease of winding and strength.

The coiled portion 4a of the filament coil 4 is in a doubly wound state. This is achieved by first forming a single coil by winding a wire into a spiral shape with a substantially constant pitch, and then forming a double coil by winding the single coil into a spiral shape. As one example, the single coil may have an outer diameter of 0.15 [mm] and a pitch of 0.07 [mm], and the ultimate coiled portion 4a may have an outer diameter of 1.3 [mm] and a pitch of 0.6 [mm].

An electron emissive material 3a is deposited on the surface of the coiled portion 4a of the filament coil 4. The main constituent of the electron emissive material 3a may be an oxide of a ternary alkaline earth metal made up of barium (Ba), strontium (Sr), and calcium (Ca). The main constituent of the electron emissive material 3a is not limited to the stated material, and may be a binary barium oxide, or may be an oxide of an alkaline earth metal with 1% to 5% by weight of zirconium oxide added thereto.

The sleeve 7 covers the coiled portion 4a of the filament coil 4. The sleeve lead 8 extends from an outer surface of the sleeve 7 toward the closer end of the bulb 2. The sleeve lead 8 may be made of stainless steel (SUS304), for example.

Each of the connecting members 5a and 5b are in the form of plate. The exposed end of the sleeve lead 8 as well as the exposed ends of the first and second lead portions 4b and 4c are separately fixed to one of the connecting members 5a and 5b . As one example, the plate-shaped connecting members 5a and 5b are mainly made of stainless steel (SUS304) and each measure 5 [mm] in height, 2.5 [mm] in width, and 0.2 [mm] in thickness. At each end of the bulb 2, a pair of lead-in wires 6a and 6b is provided through the end of the bulb 2 to energize the first lead portion 4b and the second lead portion 4c, respectively. The ends of the lead-in wires 6a and 6b contained inside the bulb 2 are fixed to the connecting members 5a and 5b.

As described above, the connecting member 5a connects the first lead portion 4b to the lead-in wire 6a, whereas the connecting member 5b connects the second lead portion 4c to the lead-in wires 6b. Therefore, the connecting members 5a and 5b function as feeder members through which electric power is supplied to the filament coil 4 upon voltage application to the lead-in wires 6a and 6b.

In the present embodiment, the sleeve lead 8 and the first lead portion 4b are fixed to one main surface of the plate-shaped connecting member 5a, and the lead-in wire 6a is fixed to the other main surface of the plate-shaped connecting member 5a. Similarly, the second lead portion 4c is fixed to one main surface of the plate-shaped member 5b, and the lead-in wire 6b is fixed to the other main surface of the plate-shaped member 5b.

Since the respective ones of the first and second lead portions 4b and 4c are connected to the respective ones of the lead-in wires 6a and 6b via the connecting members 5a and 5b, the filament coil 4 can be more accurately positioned at the time of assembling the lamp 1, compared to the case where first and second lead wires are connected to respective lead-in wires without using connecting members. In addition, the use of the connecting members 5a and 5b allows the first and second lead portions 4b and 4c to be connected to the respective ones of the lead-in wires 6a. and 6b more easily than when connecting members are not used.

The sleeve lead 8 is not necessarily supported by the connecting member 5a, and may be supported by the connecting member 5b instead.

Although the coiled portion 4a of the filament coil 4 according to the present embodiment is a double coil (double helical structure) , the coiled portion 4a may alternatively be a triple coil (triple helical structure) or a single coil (single helical structure).

With a coiled coil structure (multiplex winding structure), the coiled portion 4a of the filament coil 4 is made more compact as compared with the single coil structure (single helical structure), which leads to improve the design flexibility of the lamp 1.

An overview of a specific method for driving the hot-cathode fluorescent lamp of the present invention is now given. In order to apply voltage across the first and second lead portions 4b and 4c of the electrode unit 3, a voltage of 5 [V], for instance, is applied across the lead-in wires 6a and 6b. As a result, the electron emissive material 3a is heated by the filament coil 4.

Then, a voltage of 300 [V], for instance, is applied between the electrode units 3, causing electrons to be emitted from the electron emissive material 3a to generate arc discharge between the electrodes units 3. After arc discharge is generated between the electrode units 3, control is exercised so that a voltage of 100 [V] is applied across the electrode units 3, and a voltage of 2 [V], for example, is applied to each of the electrode units 3. Although the application of the 2 [V] voltage is optional, this leads to longer lamp life.

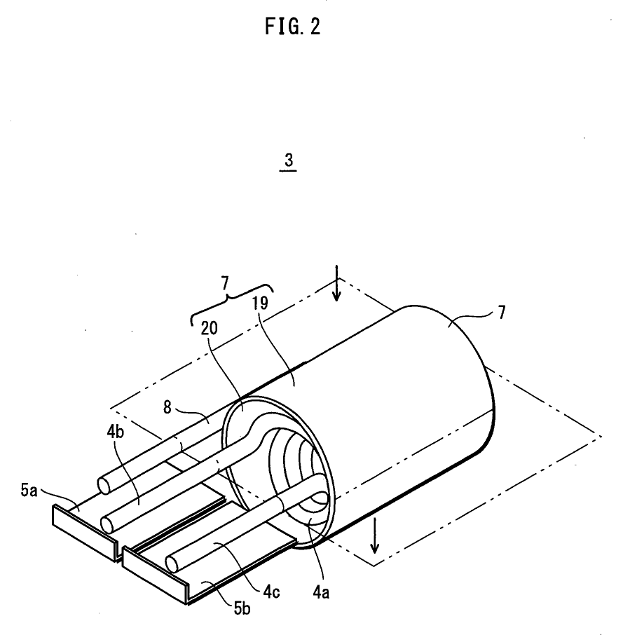

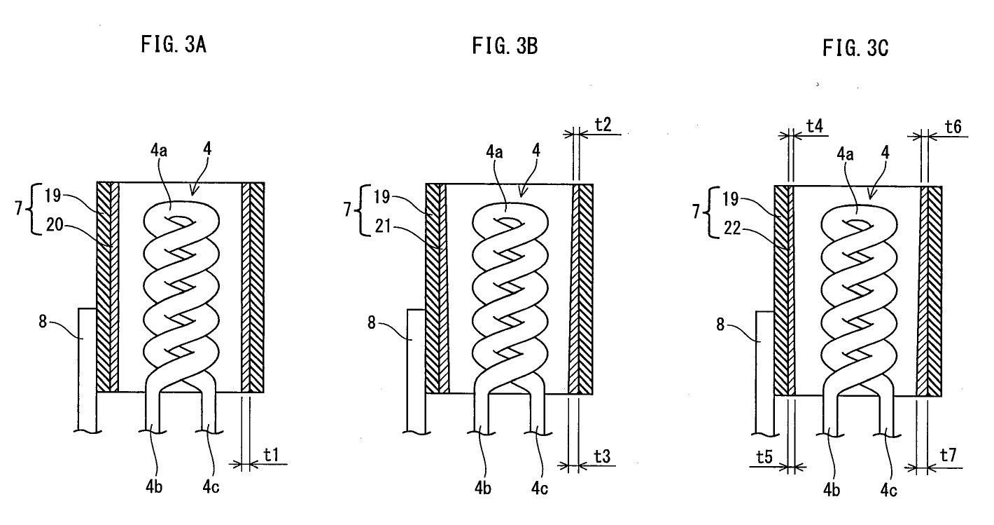

FIG. 2 is a schematic perspective view of the electrode unit, and FIGS. 3A-3C are schematic cross-sectional views of variations of the electrode unit, taken along a virtual plane shown in FIG. 2. In each of FIGS. 3A-3C, only the sleeve is shown in cross section, and the electron emissive material coating the coiled portion of the filament coil is not shown.

As shown in FIG. 2, the sleeve 7 according to the first embodiment is composed of a tubular body 19 and an insulating film 20. The tubular body 19 is made of nickel and has open ends. The insulating film 20 is formed on the inner circumferential surface of the body 19.

As shown in FIG. 3A, the insulating film 20 has a uniform thickness t1, which may fall within the range of 0.002-1 [mm], for example.

Although the insulating film 20 according to the first embodiment is formed to cover the entire inner circumferential surface of the body 19, it is also sufficient that the insulating film is formed to cover a localized region of the inner circumferential surface of the body 19 that is closer to the first and second lead portions 4b and 4c of the filament coil 4.

The insulating film 20 is formed in the following manner. A glaze mainly containing an oxide such as aluminium oxide (Al₂O₃) , silica (SiO₂), or titanium oxide (TiO₂), or a nitride such as boron nitride (BN) is prepared. The glaze is applied to the inner circumferential surface of the body 19, followed by baking for approximately 10 minutes at about 1200 [+ C.]. As a result, the insulating film 20 is formed to coat the inner circumferential surface of the body 19. Note that in the stated insulating film formation method using the glaze, it is preferable to carry out the process in an oxygen deficiency atmosphere in order to prevent oxidization of the body 19 on which the insulating film is being formed.

As one example, if a glaze containing a mixture of silica powder and boric acid is applied and baked under the above-stated conditions, the silica present in the insulating film 20 is enveloped by the boric acid that has melted due to the baking.

Alternatively, the insulating film 20 may be formed in the following manner. First of all, a paste or slurry is prepared by dispersing the powder described below in a dispersion medium such as a petroleum-based carbide, a carboxylate ester or an alcohol so as to achieve a predetermined viscosity. The powder mainly contains: a nitride such as boron nitride (BN), silicon nitride (Si₃N₄) , or the like; a carbide such as silicon carbide (SiC) or the like; or a mixture of at last two of the above-stated nitrides and carbides. The paste or slurry is then applied to the inner circumferential surface of the body 19, followed by drying at a temperature determined in view of the boiling point and the saturation vapor pressure of the dispersion medium. As a result, the insulating film 20 is formed to coat the inner circumferential surface of the body 19.

For example, the dispersion medium may be butyl acetate. In this case, a slurry having a viscosity of 0.2-2.0 [Pa s] is prepared and applied, followed by exposure to hot air of approximately 40 [° C.] for two minutes to form the insulating film 20.

In another example, any of the above-stated oxides, nitrides, carbides or the like may be baked in advance to form a tubular insulating member having open ends. The tubular insulating member is then attached to the inner circumferential surface of the body 19 using a heat-resistant adhesive, to form the insulating film 20.

For example, a mixture of silica powder and a nitride may be baked in a mold in advance to form insulating members. The insulating members may then be attached to the closest edges of the connecting members 5a and 5b using a heat-resistant adhesive.

The heat-resistant adhesive used in the present embodiment may be a heat-resistant organic adhesive that is resistant to temperatures of 1000[° C.] and higher. Examples of such heat-resistant organic adhesives include “SUMICERAM” (Registered Trademark in Japan, Trademark Registration No. 1269142) manufactured by Asahi Chemical Co., Ltd., and “Bond X” (Registered Trademark in Japan, Trademark Registration No. 2598133) manufactured by Nissan Chemical Industries, Ltd.

A further alternative is to apply a fluorescent suspension containing the same components as the fluorescent film 2a on the inner circumferential surface of the body 19, followed by drying at a temperature determined in view of the boiling point and the saturation vapor pressure of the dispersion medium. As a result, the insulating film 20 mainly containing the fluorescent is formed to coat the inner circumferential surface of the body 19.

### Variation 1

As shown in FIG. 3B, an insulating film 21 of a variation 1 of the first embodiment has a varying thickness that increases form a region closer to the bent of the coiled portion 4a (i.e. , where the coiled portion 4a is turned back) axially toward a region closer to the first and second lead portions 4b and 4C.

For example, the insulating film 21 is formed to have different thicknesses t2 and t3. The thickness t2 measured along the open end of the body 19 closer to the bent of the coiled portion is 0.05 [mm]. The thickness t3 measured along the open end of the body 19 closer to the lead portions 4b and 4c is 0.15 [mm].

The insulating film 21 having the varying thickness as described above is formed in the following manner, for example. In the case where a glaze or slurry is used, the glaze or slurry is applied to the entire inner circumferential surface of the body 19, followed by a baking process. During the baking process, the body 19 is rotated on its axis that is first held at a right angle with respect to the vertical line and then gradually inclined downwardly to form an obtuse angle with the vertical line. As a result, the insulating film 21 is configured to have the varying thickness as described above. Generally, a glaze and a slurry mutually differ in viscosity. Thus, by adjusting the speed of angular change and/or the baking temperature, the thickness of the insulating film 21 is adjusted as above.

Alternatively, a glaze or slurry is applied to the entire inner circumferential surface of the body 19 to first form an insulating film of a uniform thickness, followed by grinding with a brush having an outline defining a circular truncated cone. To be more specific, the insulating film of the uniform thickness is ground with the brush that is rotated on the corn axis held coincident with the axis of the body 19. As a result, the insulating film 21 having the varying thickness is formed.

### Variation 2

As shown in FIG. 3C, an insulating film 22 according to a variation 2 of the first embodiment has a varying thickness that increases from a region closer to the sleeve lead 8 circumferentially toward a region further away from the sleeve lead 8, as compared with the insulating film 21 according to the variation 1. The sleeve lead 8 extends in a direction of the axis of the sleeve 7.

For example, the insulating film 22 is formed to have different thicknesses t4, t5, t6, and 7. With respect to a region of the insulating film 22 circumferentially closer to the sleeve lead 8, the thickness t4 measured along the open end of the body 19 closer to the bent of the coiled portion 4a is 0.05 [mm], while the thickness t5 measured along the open end of the body 19 closer to the lead portions 4b and 4c is 0.10 [mm]. In contrast, with respect to a region of the insulating film 22 circumferentially further away from the sleeve lead 8, the thickness t6 measured along the open end of the body 19 closer to the bent of the coiled portion 4a is 0.10 [mm], while the thickness t7 measure along the open end of the body 19 closer to the bent of the coiled portion 4a is 0.15[mm].

The insulating film 22 having the varying thickness as described above is formed in the following manner, for example. In the case where a glaze or slurry is used, the glaze or slurry is applied to the entire inner circumferential surface of the body 19, followed by a baking process. During the baking process, the body 19 is rotated on its axis that is first held at a right angle with respect to the vertical line and then gradually inclined downwardly to form an obtuse angle with the vertical line. In addition, the rotation of the body 19 is stopped before completing the baking. As a result, the insulating film 22 is configured to have the varying thickness as described above. Generally, a glaze and a slurry mutually differ in viscosity. Thus, adjusting the speed of angular change, the baking temperature, and/or the timing for the rotation stop, the thickness of the insulating film 22 is adjusted as above.

Alternatively, a glaze or slurry is applied to the entire inner circumferential surface of the body 19 to first form an insulating film of a uniform thickness, followed by grinding with a brush having a conical outline. To be more specific, the insulating film of the uniform thickness is ground with the brush that is rotated on the corn axis held eccentrically with respect to the axis of the body 19. As a result, the insulating film 22 having the varying thickness is formed.

### Effects of Hot-Cathode Fluorescent Lamps of First Embodiment

According to the first embodiment, the sleeve 7 has the insulating film 20 of a uniform thickness that covers the entire inner surface of the body 19. The provision of the insulating film 20 prevents a short circuit between the sleeve 7 and the filament coil 4 resulting from arc discharge generated, upon application of voltage to the filament coil 4 via the lead-in wires 6a and 6b (see, FIG. 1B) , at a location where the sleeve 7 and the filament coil 4 are closest to each other. Consequently, the electron emissive material 3a applied to the coiled portion 4a of the filament coil 4 is protected from being excessively sputtered and thus from being excessively consumed. As a result, a decrease of the lamp life is prevented.

Upon application of voltage to the filament coil 4, the potential difference is expected to be largest between the first lead portion 4b of the coiled portion 4a and the sleeve 7 or between the second lead portion 4c of the coiled portion 4a and the sleeve 7.

As already stated above, the insulating film 20 may be provided to locally cover a region of the inner circumferential surface of the body 19 closer to the first and second lead portions 4b and 4c of the filament coil 4. In such a case, the insulating film 20 is located to cover at least a region of the inner surface of the sleeve 7 corresponding to where the potential difference is expected to be largest. With this arrangement, occurrence of a short circuit is effectively prevented. Consequently, the electron emissive material 3a applied to the coiled portion 4a of the filament coil 4 is protected from being excessively sputtered and thus from being excessively consumed As a result, a decrease of the lamp life is prevented.

Note that the insulating film 20 may be provided to cover the entire inner circumferential surface of the body 19 to prevent occurrence of a short circuit even more reliably, and thus prevents a decrease of the lamp life even more reliably.

The potential difference between the coiled portion 4a and the inner circumferential surface of the sleeve 7 is larger at a location closer to the bend of the coiled portion 4a than at a location closer to the first and second lead portions 4b and 4c. In view of this, the insulating film 22 according to the variation 1 is thicker at a region closer to the first and second lead portions 4b and 4c than at a region closer to the bend of the coiled portion 4a. Thus, the insulating film 22 reliably prevents a short circuit at a region of the inner circumferential surface of the sleeve 7 where a short circuit is most likely to occur and also prevents a short circuit at the other region of the inner circumferential surface. Consequently, the electron emissive material 3a applied to the coiled portion 4a of the filament coil 4 is protected from being excessively sputtered and thus from being excessively consumed. As a result, a decrease of the lamp life is prevented.

According the present embodiment, since the winding axis of the coiled portion 4a coated with the electron emissive material 3a is substantially parallel to the tube axis of the bulb 2, ions generated during discharge predominantly collide with the bend of the coiled portion 4a. Hence, ion sputtering is suppressed in most part of the coiled portion other than the bend. This suppresses depletion of the electron emissive material 3a, and therefore suppresses reduction in lamp life.

Furthermore, since the winding axis of the coiled portion 4a is substantially parallel to the tube axis of the bulb 2, the diameter of the bulb 2 can be reduced without reducing the length of the filament coil 4, therefore allowing more flexibility of design of the lamp 1.

Reducing the diameter of the bulb 2 enables the intensity of the lamp to be improved. Since the winding axis of the coiled portion 4a is substantially parallel to the tube axis of the, bulb 2, the diameter of the bulb 2 can be reduced without a reduction in the total area of the coiled portion 4a over which the electron emissive material 3a is applied. Therefore, the intensity of the lamp can be improved while suppressing reduction in lamp life.

According to the present embodiment, the sleeve 7 is provided to cover the coiled portion 4a of the filament coil 4. The provision of the sleeve 7 further suppresses sputtering by the ions generated during discharge. Thus, reduction in lamp life is further suppressed.

In the case where the coiled portion 4a of the filament coil 4 has a multiple-coiled coil structure, the winding axis of the most outer winding of the coiled portion 4a is substantially parallel to the tube axis of the bulb 2. As a result, the effect similar to that described above is also achieved.

Regarding each filament coil 4 according to the first embodiment, the winding axis of the coiled portion 3a which is coated with the electron emissive material 3 is substantially parallel to the axis of the bulb 2. Yet, the winding axis of the coiled portion coated with the electron emissive material may be perpendicular to the axis of the bulb. Even in this case, the provision of the sleeve covering the coiled portion still protects the electron emissive material from being sputtered by ions generated during discharge, especially at part of the coiled portion closer to the end of the bulb as well as part around the ends of the coiled portion. As a result, a decrease of the lamp life is prevented.

According to the variation 1 of the first embodiment, the insulating film 21 is thinner at a location corresponding to a region of the inner circumferential surface of the sleeve 7 where the risk of short circuit is lower than at location corresponding to a region where the risk is higher. This arrangement serves to reduce the cost.

The potential difference between the coiled portion 4a and the inner circumferential surface of the sleeve 7 is expected to be largest at locations on the coiled portion 4a that are axially closer to the first and second lead portions 4b and 4c and are circumferentially further away from the sleeve lead 7.

According to the variation 2 of the first embodiment, the sleeve lead 8 is supported by the connecting member 5a. Thus, the insulating film 22 is made thicker at a region that is circumferentially further wary from the sleeve lead 8 (at a region closer to the second lead portion 4c), as compared with a region that is circumferentially closer to the sleeve lead 8 (at a region closer to the first lead portion 4b). With this arrangement, the insulating film 22 reliably prevents a short circuit at a region of the inner circumferential surface of the sleeve where a short circuit is most likely to occur and also prevents a short circuit at a location corresponding to the other regions of the inner circumferential surface. Consequently, the electron emissive material 3a applied to the coiled portion 4a of the filament coil 4 is protected from being excessively sputtered and thus from being excessively consumed. As a result, a decrease of the lamp life is prevented.

As described above, the sleeve lead 8 is not necessarily supported by the connecting member 5a, and may be supported by the connecting member 5b instead. In this case, the insulating film 22 is made thicker at a region circumferentially closer to the first lead portion 4b than at a region circumferentially closer to the second lead portion 4c. With this arrangement, the effect of preventing a short circuit is similarly achieved.

The insulating film 22 according to the variation 2 of the first embodiment is thicker at a region circumferentially further away from the sleeve lead 8 than at a region circumferentially closer to the sleeve lead 8, as compared with the insulating film 21 according to the variation 1. Yet, the insulating film 22 maybe modified based on the insulating film 20 having a uniform thickness throughout the entire inner circumferential surface of the body 19. That is, the modified insulating film 22 has a thickness that is uniform in the axial direction but varies in the circumferential direction. This modification still achieves the same effect of preventing a short circuit.

According to the first embodiment, the sleeve 7 is composed of the insulating film 20 and the conductive body 19 that is made of a material such as nickel (N). Alternatively, however, the sleeve may be made entirely of an insulating material and still achvies the effect of preventing a short circuit at a location where the sleeve and the filament coil is closest to each other. Thus, a decrease of the lamp life is prevented. In addition, the sleeve lead 8 may be modified so that the exposed end of the sleeve lead 8 is not connected to either of the connecting members 5a and 5b but to another component. For example, the exposed end of the sleeve lead may extend out through the end of the bulb 2. This modification may be made in a manner to reduce the potential difference between the sleeve 7 and the filament coil 4 at a location where the sleeve 7 and the filament coil 4 are closest to each other. In addition, the effect of preventing a short circuit is still achieved and thus a decrease of the lamp life is prevented.

The insulating films 20, 21, and 22 may be made from fluorescent material. With this modification, the respective insulating films serve to effectively convert ultraviolet radiation resulting from discharge into visible light, thereby improving the luminous efficiency. Alternatively, the insulating films 20, 21, and 22 may be made from a material having ultraviolet reflectivity. Examples of such ultraviolet reflective materials include aluminium oxide (Al₂O₃) and titanium oxide (TiO₂). With this modification, ultraviolet radiation resulting from discharge is effectively directed to the fluorescent film 2a coating the inner surface of the bulb 2, thereby improving the luminous efficiency.

According to the variation 2, the insulating film 22 is thinner at a location corresponding to a region of the inner circumferential surface of the sleeve 7 where the risk of short circuit is lower than at location corresponding to a region where the risk is higher. This arrangement serves to reduce the cost.

As described above, the insulating films 20, 21, and 22 may be formed to cover the entire circumferential surface of the body 19. In this case, the sleeve 7 is reliably insulated even if the sleeve 7 is physically in contact with the coiled portion 4a of the filament coil 4, which improves the design flexibility of the diameter of the sleeve 7 and thus improves the design flexibility of the bulb 2.

### INDUSTRIAL APPLICABILITY

According to the present invention, reduction in lamp life can be suppressed, and therefore the lamp replacement period can be extended. By using a lamp of the present invention, a maintenance-free lighting apparatus can be realized in relation to life cycle of the product, and therefore the lamp of the present invention can has extremely wide and great industrial applicability.

1. A hot-cathode fluorescent lamp comprising:
a glass bulb;
a pair of filament coils disposed in respective ends of the glass bulb, each filament coil having a coiled portion coated with an electron emissive material; and
a heat-resistant sleeve disposed to cover one of the coiled portions, wherein
a winding axis of each coiled portion is substantially parallel to a tube axis of the glass bulb, and
the heat-resistant sleeve includes (i) a tubular conductive body having open ends, and (ii) an insulating film attached to an inner circumferential surface of the conductive body to cover a localized region of the inner circumferential surface.

2. (canceled)

3. (canceled)

4. A hot-cathode fluorescent lamp, comprising:
a glass bulb;
a pair of filament coils disposed in respective ends of the glass bulb, each filament coil having a coiled portion coated with an electron emissive material;
a pair of feeder members through which electric power is supplied to the respective filament coils; and
a heat-resistant sleeve disposed to cover one of the coiled
portions, wherein
a winding axis of each coiled portion is substantially parallel to a tube axis of the glass bulb,
the heat-resistant sleeve includes (i) a tubular conductive body having open ends and supported by one of the feeder members, and (ii) an insulating film attached to an inner circumferential surface of the conductive body, and
the insulating film is thicker at a region corresponding to where a potential difference between the conductive body and the coiled portion occurring upon voltage application is larger than at a region corresponding to where the potential difference is smaller, with respect to regions where a distance between the conductive body and the coiled portion is shortest.

5. A hot-cathode fluorescent lamp, comprising:
a glass bulb;
a pair of filament coils disposed in respective ends of the glass bulb, each filament coil having a coiled portion coated with an electron emissive material and a first lead portion and a second lead portion each extending from respective ends of the coiled portion toward a closer one of the ends of the glass bulb; and
a heat-resistant sleeve disposed to cover one of the coiled portions, wherein
a winding axis of each coiled portion is substantially parallel to a tube axis of the glass bulb,
the heat-resistant sleeve includes (i) a tubular conductive body having open ends, and (ii) an insulating film attached to an inner circumferential surface of the conductive body,
the first and second lead portions of said one of the filament coil extend beyond one of the open ends of the sleeve adjacent the closer end of the glass bulb, and
the insulating film is thicker at a region axially closer to the closer end of the glass bulb than at a region further away from the closer end of the glass bulb.

6. A hot-cathode fluorescent lamp, comprising:
a glass bulb;
a pair of filament coils disposed in respective ends of the glass bulb and having a coiled portion coated with an electron emissive material and a pair of led portions extending from respective ends of the coiled portion,
a pair of feeder members through which electric power is supplied to the respective filament coils;
a heat-resistant sleeve disposed to cover a corresponding one of the coiled portions; and
a sleeve lead extending from the conductive body in a direction axially of the sleeve and connected to one of the feeder members, wherein
a winding axis of each coiled portion is substantially parallel to a tube axis of the glass bulb,
the heat-resistant sleeve is supported by said one of the feeder members via the sleeve lead and includes (i) a tubular conductive body having open ends, and (ii) an insulating film attached to an inner circumferential surface of the conductive body, and
the insulating film is thicker at a region circumferentially closer to the sleeve lead than at a region circumferentially further away from the sleeve lead.

7. The hot-cathode fluorescent lamp of claim 1, wherein
each coiled portion is a multiple-coiled coil composed of a winding of (i) a single coil that is composed of a spirally wound wire or (ii) another multiple-coiled coil ultimately composed of the single coil, and
the winding axis parallel to the axis of the glass bulb is an axis of an outermost one of the coil windings.

8. The hot-cathode fluorescent lamp of claim 4, wherein
each coiled portion is a multiple-coiled coil composed of a winding of (i) a single coil that is composed of a spirally wound wire or (ii) another multiple-coiled coil ultimately composed of the single coil, and
the winding axis parallel to the axis of the glass bulb is an axis of an outermost one of the coil windings.

9. The hot-cathode fluorescent lamp of claim 5, wherein
each coiled portion is a multiple-coiled coil composed of a winding of (i) a single coil that is composed of a spirally wound wire or (ii) another multiple-coiled coil ultimately composed of the single coil, and
the winding axis parallel to the axis of the glass bulb is an axis of an outermost one of the coil windings.

10. The hot-cathode fluorescent lamp of claim 6, wherein
each coiled portion is a multiple-coiled coil composed of a winding of (i) a single coil that is composed of a spirally wound wire or (ii) another multiple-coiled coil ultimately composed of the single coil, and
the winding axis parallel to the axis of the glass bulb is an axis of an outermost one of the coil windings.

11. The hot-cathode fluorescent lamp of claim 7, wherein
the coiled portion is a double coil composed of a single coil that is would with a substantially constant pitch, the single coil being composed of a wire that is would in spiral with a substantially constant pitch.

12. The hot-cathode fluorescent lamp of claim 8, wherein
the coiled portion is a double coil composed of a single coil that is would with a substantially constant pitch, the single coil being composed of a wire that is would in spiral with a substantially constant pitch.

13. The hot-cathode fluorescent lamp of claim 9, wherein
the coiled portion is a double coil composed of a single coil that is would with a substantially constant pitch, the single coil being composed of a wire that is would in spiral with a substantially constant pitch.

14. The hot-cathode fluorescent lamp of claim 10, wherein
the coiled portion is a double coil composed of a single coil that is would with a substantially constant pitch, the single coil being composed of a wire that is would in spiral with a substantially constant pitch.

15. The hot-cathode fluorescent lamp of claim 1, wherein
each filament coil further includes a first lead portion and a second lead portion extending from respective ends of the coiled portion,
the heat-resistant sleeve has a sleeve lead extending in a direction axially of the sleeve, and
the sleeve lead is electrically independent from the first and second lead portions of said one filament coil.

16. (canceled)

17. (canceled)

18. (canceled)

19. (canceled)

20. The hot-cathode fluorescent lamp of claim 4, wherein
each filament coil further includes a first lead portion and a second lead portion extending from respective ends of the coiled portion,
the heat-resistant sleeve has a sleeve lead extending in a direction axially of the sleeve, and
the sleeve lead is electrically independent from the first and second lead portions of said one filament coil.

21. The hot-cathode fluorescent lamp of claim 5, wherein
each filament coil further includes the first lead portion and the second lead portion extending from the respective ends of the coiled portion,
the heat-resistant sleeve has a sleeve lead extending in a direction axially of the sleeve, and
the sleeve lead is electrically independent from the first and second lead portions of said one filament coil.
